(19) United States
(12) Patent Application Publication
(10) Pub. No.: US 2013/0322110 A1
(43) Pub. Date: Dec. 5, 2013

(54) Lighted Floor Panels and Portable Lighted Stage Systems Comprised of Same

(71) Applicants: Jose Cantu, Gardena, CA (US); Alfredo Gomez, Gardena, CA (US)

(72) Inventors: Jose Cantu, Gardena, CA (US); Alfredo Gomez, Gardena, CA (US)

(21) Appl. No.: 13/488,986

(22) Filed: Jun. 5, 2012

(51) Int. Cl. F21S 8/00; F21V 8/00

(52) U.S. Cl. 362/602; 362/153

(57) ABSTRACT

A lighted floor system has been invented to facilitate quick temporary installation, and ease of removal whereby the floor is particularly suitable for highly durable applications. A durable and inexpensive modular system permits these devices to be used as flooring for high-performance lighted stage is suitable for use in concerts and other performing art expositions. In particular, these lighted floor systems presented herein are formed of a ‘repeat unit’ element which may be affixed to similar or identical units in a paving scheme to cover a large area floor space. Each repeat unit includes one or more light panels to provide highly dynamic color light outputs of high uniformity with respect to the illumination fields. These panels include a construction suitable for high durability—i.e. they support being walked on; highly portable they support quick installation—uninstallation; and are quite inexpensive due to their unique construction.

### BACKGROUND OF THE INVENTION

1. Field

The following invention disclosure is generally concerned with portable stage equipment and specifically concerned with highly durable lighted flooring systems suitable for use as concert staging.

2. Background

Lighted floor systems are hardly new. Indeed the art is replete with clever arrangements, each of which provide useful characteristics and attributes particular to those designs in view of the objectives for which they serve. In most versions up to recent times, incandescent bulbs were used as light sources. Because light emitting diodes now produce light in very high intensity, there are significant advantages to arrange lighted floor systems about LEDs. Some of the more modern lighted floor systems found in the art include LED based systems and designs based upon LED light sources are fundamentally different that those of previously used sources.

In some particular illustrative examples, early designers and inventors enjoyed providing novel approaches for making ‘disco dance’ type lighted floors from panels which emanated light of various colors and sometimes dynamically changing colors. In 1978 inventor Deaven from Hollywood, Calif. taught of a portable container which converts to a lighted dancing stage. This invention described in U.S. Pat. No. 4,120,025 addresses at least one very important concept. While most lighted floors are intended and designed about a scheme whereby the installation is permanent, inventor Deaven has anticipated a stage which is first installed, and after some limited use, is collected up again and transported to another location where it may be reinstalled for further use at a second location. Some important uses of stage equipment demand that it be portable and thus it must support assembly, disassembly and reassembly. Many interesting arrangements of lighted floors taught throughout the years provide excellent results and performance yet they do not support portability. Portability for some applications of staging equipment including lighted floors is basis for the particular designs used.

Another portable lighted floor system is presented in U.S. Pat. No. 4,329,739 issued in 1982 also makes portability a foundation of the concept. Inventor Loebner also recognizes the need for easy transport and reassembly for use of his floors in more than one location. As such, the lighted floor system is useful as a temporary performance stage suitable for reuse at various venues.

Harrison teaches important lighted floor systems which include thin ‘paver’ elements with LED type light sources integrated therein. However in U.S. Pat. No. 4,737,764 it is clear that the nature of construction and configuration suit a permanent installation such as in a movie theater.

As such, Harrison's modular floors are not good candidates for applications where reinstallation is desirable. However Harrison's teachings show excellent structures which support the lighted panels and arrays of same to be inserted into receiving grids fabricated of metal cross hatching.

A lighted automotive floor mat system is described in U.S. Pat. No. 6,481,877 which is issued in 2002. While these floor mats are indeed ‘portable’ and ‘removable’, they are nevertheless comprised of many structures and features which render them less than ideal for use in larger area staging applications.

Hoffman presents in U.S. Pat. No. 6,523,986 a lighted signal device for integrated with floors. Hoffman's system is distinct from lighted floor systems as it presents marker signal type lights rather than illuminated floors.

Sandor Sr. teaches of an illuminated glass deck panels. These systems of glass pavers and structural plank elements as described in U.S. Pat. No. 7,021,786 support for illumination in permanent installations.

An important panel periphery side lighting scheme including those of non-rectilinear peripheries is shown by McNaught in U.S. Pat. No. 7,494,258. The systems are suitable for use as floors as well as walls, panels, ceilings etc. This construction is not suitable for use as temporary staging systems.

Jacobson of U.S. Pat. No. 8,092,036 presents important concepts where LED light sources are tightly integrated with floor materials to yield lighted marker systems.

Dutch company Philips Electronics recently patented their concept of a lighted floor system in the U.S. Pat. No. 8,128,253 of Mar. 6, 2012. This important peripheral side eliminated floor includes a waveguide system and support apparatus. The device is well-suited for color illuminated floors of high brightness and saturation however, the systems presented by Philips do not support portability and reinstallation. Rather, they are single forum committed installations of very small area as they are necessarily integrated with a adjacent wall or panel. While they provide high brightness performance in a thin package, the systems do not include provisions for improved uniformity of the illumination field. In addition as the wear surface is permanently affixed to the waveguide, lifetime is limited to the life of that surface which remains susceptible to heavy wear and is easily damaged through thus rendering the entire system suitable for very light duty applications only.

### SUMMARY OF THE INVENTION

Lighted floor systems particularly suited for use as a temporary reusable performance stage is configured about highly durable but inexpensive design schemes. Additionally, the designs incorporate features which facilitate installation and uninstallation of these portable and reusable lighted floor systems. As such, highly attractive lighted stage systems are comprised of an array of cooperating modules which easily fastened to each other and support integration with thin light panels of durable construction.

These modular stage systems particularly comprised a frame unit which is of a size whereby it may be easily handled and manipulated by a single man. This frame is best fabricated from a specially designed extruded metal which includes features for coupling to adjacent units, coupling to a subfloor, and further coupling to light panels which may be inserted into receiving cavities formed therein said frame unit. In some preferred versions, a frame is constructed to accommodate two square light panels each being approximately about 4 feet in length on each side. Light panels are made of particular construction to support important objectives associated with use as temporary staging. A primary attribute of these light panels includes a need to couple and integrate with the frame units which received them. Light panels are shaped and fitted to fit within a receiving space of a frame unit. The light panels having a plurality of light sources distributed about its periphery is preferably square in shape and includes special means for enhanced coupling of light therefrom to improve uniformity. In systems having highest durability and strength demands, these light panels may gain strength by including a backing board of common plywood and the frames are appropriately adjusted to accommodate such assembly.

Yet further, another objective of these lighted floor systems with particular regard to the light panel portions thereof is durability. Because stage applications tend to put extreme wear on panels used for this application, versions of these light panels may include a protective sheet which isolates a waveguide from wear forces where the protective sheet is easy to remove and replace.

In contrast to typical stage systems which tend to be permanent, it is an objective of these systems to support temporary use in one location and an uninstall feature whereby the pieces are readily removed, transported to another location and reinstalled.

Another feature and function relates to a system which is very inexpensive to produce. While many system configurations are available which produce attractive lighting for floors, those designs tend to ignore the practical aspect of large scale applications for commercial use and deploy arrangements which would be prohibitively expensive when used in very large stages appropriate for professional concert productions. In professional concert applications, the overall cost could exceed practical limits if those size-limited breadboard designs were attempted to be scaled.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is side view line diagram showing an example version of a waveguide element portion of a lighted panel;

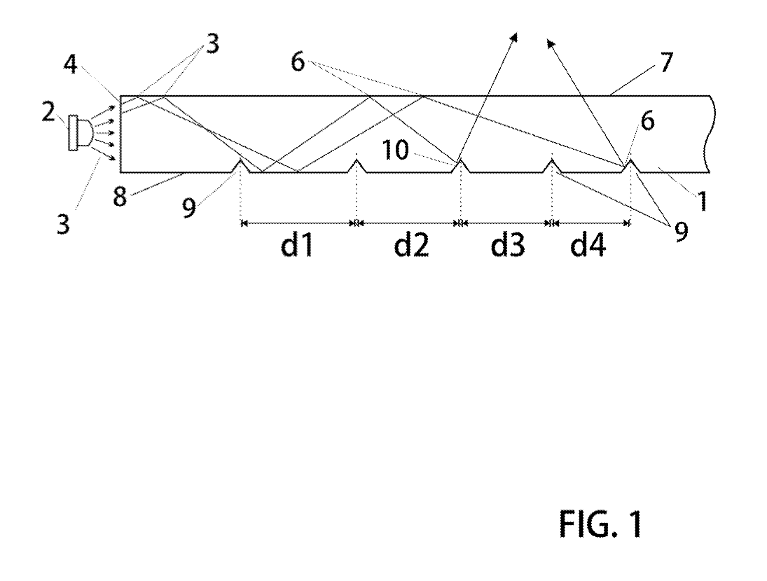

FIG. 2 is a similar line diagram of a side view which further includes a protective scatter sheet and a backplane element; and

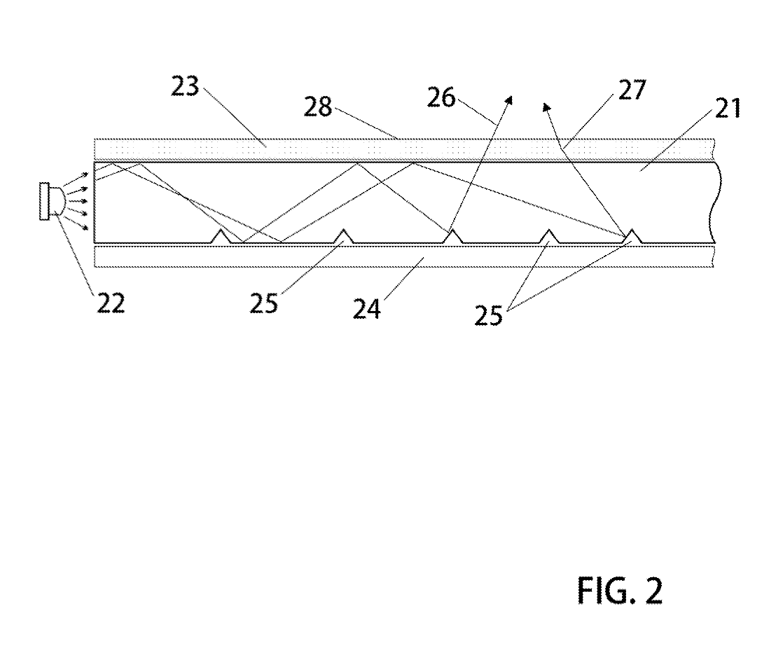

FIG. 3 illustrates an important removable coupling between a protective scatter sheet and a waveguide element;

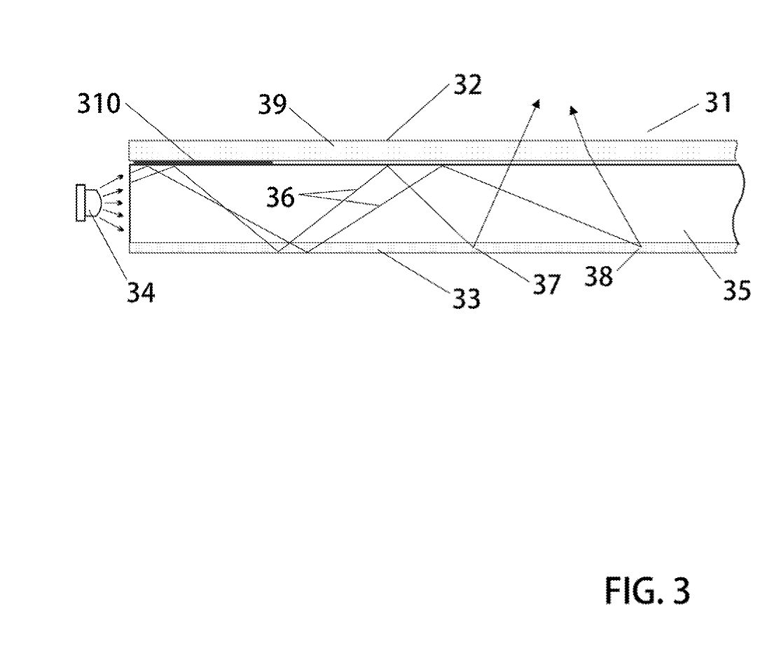

FIG. 4 shows a peripheral mounting system or edge bracket suitable for accommodating light sources therein and integrating with these waveguides;

FIG. 5 is a perspective view of the edge bracket with light sources therein;

FIG. 6 illustrates an alternative mounting for direct integration with the waveguide;

FIG. 7 shows special nonuniform scoring used in some waveguide versions;

FIG. 8 shows an important highly durable rail used for support of these lighted panels;

FIG. 9 shows lighted panels assembled in a temporary installation where a rail, support plane and lighted panel are in relation with each other;

FIG. 10 shows a two panel repeat unit from which a temporary stage floor is readily constructed and/or assembled;

FIG. 11 shows a stage floor of many repeat units having rectangular peripheries; and

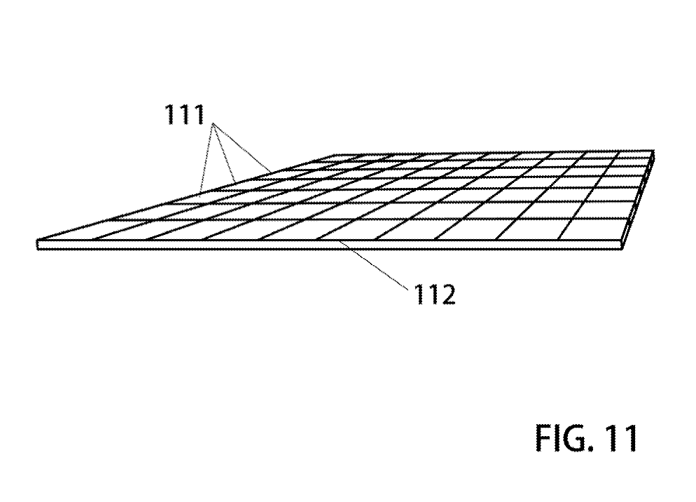

FIG. 12 shows an alternative stage floor where each panel and support structure is fashioned with a hexagon periphery.

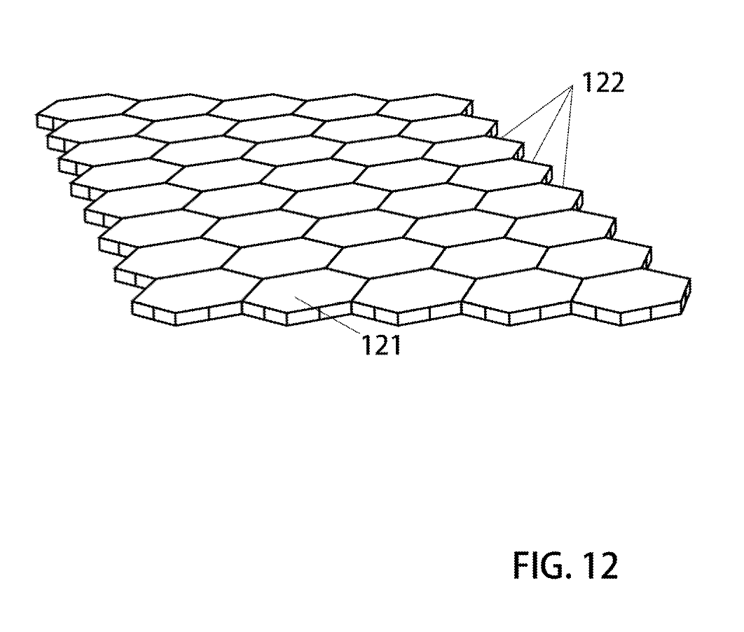

### PREFERRED EMBODIMENTS OF THE INVENTION

The foundation upon which most preferred versions of these systems are built includes a side illuminated waveguide 1. These waveguides are characterized as large two-dimensional planar slabs of optically transparent material of high strength and durability. One important useful material which is suitable in most versions is a Plexiglas plastic material. A light source 2 such as a high brightness LED or laser semiconductor emits light when stimulated by electrical current. Light rays 3 emitted by light sources may enter the waveguide at an optically polished face 4. Light rays propagate within the waveguide and are substantially contained therein in part by total internal reflections 6 at the waveguide top 7 and bottom 8 surfaces. The bottom surface may be specially prepared with ‘scoring’ or surface ‘imperfections’ or disruptions to the otherwise optically smooth surface. Scored grooves 9 for example provide sites which tend to interrupt regular internal reflections and thus waveguide containment of light propagating therein. Light rays which fall incident upon these scoring grooves tend to get reflected 10 in a manner whereby a substantial amount of light is permitted to leave the waveguide. The collection of grooves together operate as an optical output coupling.

As light is so coupled out of the waveguide, the intensity of light remaining in the propagating beam within the waveguide is decreased. Since the beam is of decreased intensity at distances far from the light source, it requires an increase in the spatial density of score marks to cause a similar amount of light to leave the waveguide from waveguide locations which are far from the light source. Accordingly, the distance ‘d’ between score grooves or score marks is less as one moves away from the light source. That is, d1>d2>d3>d4. In this fashion, one can achieve a more even spatial distribution of light emanated from the top surface of the waveguide. In certain uses of lighted floor systems, a primary desirable characteristic is uniform illumination. Often, various geometries attempted in the arts left unsightly ‘hotspots’ and uneven lighting. Where those who precede us have achieved even lighting, they were able to manage this at considerable expense as geometries which can achieve even illumination fields usually require expensive and difficult to construct arrangements.

While a substantially planer transparent ‘slab’ element 21 serves as a waveguide to carry light from a semiconductor light source 22, this waveguide is preferably supported by complementary and cooperating elements including a protective scatter sheet 23 and a backplane element 24. These may be physically bound to the waveguide directly or merely a fixed adjacent thereto.

The functions of the protective scatter sheet include protecting the optical integrity of the waveguide top surface which might otherwise be exposed to very strong wear forces which adversely affect optical performance of the waveguide, and diffusing light in a manner whereby light emitted by system is highly uniform and evenly spread over large areas.

Because the primary use of these lighted floor systems includes use in conjunction with concert and performing arts stage apparatus, it is expected that significant loads and wear forces will be exerted at the floor surface. While some waveguide materials (such as plexiglass polycarbonate) are very durable, and suitable for some limited uses in flooring applications, these systems exhibit particular adverse effect where the surface suffers from excess scratching due to wear. If a waveguide were left unprotected, scratching at its surface incurred during normal use would cause uneven optical ‘leaks’ at the top surface providing very bright lines quite undesirable in view of the objective of even and uniform lighting. Therefore, these systems require a top surface which can be heavily scratched yet still produce very even and homogenous lighting effect. Accordingly upon the top surface of the waveguide, a thin protective scatter sheet of plastic is disposed. In best versions, this protective scatter sheet may be a thin (approximately 1/16 of an inch) ‘Lexan’, ‘frosted’ sheet of polymer material. A frosted material permits very good light transmission therethrough while at the same time being highly impervious to even heavy scratching. Light reflected from scoring grooves 25 leaves the waveguide by way of the protective scatter sheet. In some cases, the light is further scattered via optical imperfections 27 within the scatter sheet. The top surface of the scatter sheet may be scuffed and scratched quite heavily without effecting performance of the waveguide which continues to yield an even emission of light therefrom. When a scatter sheet is finally wore excessively, it is easily removed and replaced with a fresh one.

Since the fundamental nature of a floor 31 includes a primary surface exposed to high wear activity, these systems are arranged to couple light preferentially through the top surface 32 of the system and to reduce loss of light at the bottom surface. Therefore, some important versions of these floor systems include a backplane element 33 affixed adjacent to the bottom side of the waveguide. It is a function of this backplane element to return any light leaving the waveguide from the bottom surface back into the system. The backplane element therefore may be arranged as a highly reflective surface such as a mirror. However since reduction of cost is an important consideration in these floor systems in most versions, it is not necessary to use a polished optical surface at the backplane element. Rather, a white scattering surface serves well to couple light into the illumination fields which leave the top surface of the lighted panel as light incident thereon the backplane element is reflected upwardly and into the light field which is emitted from the top surface. Light originating at LED light source 34 enters the two-dimensional planar slab waveguide 35 at a side face. Light rays 36 propagate within the waveguide to experience internal reflections at the top and bottom surfaces as shown in the diagram. When the backplane element is fashioned as a specially prepared thin film, it may include non-uniform spatially distributed scattering sites 37 and 38. Light incident on these scattering sites may be coupled out of the waveguide and into a beam or light field which exits the waveguide at the top surface as shown by the ray paths in the image. A backplane element embodied as such film may be affixed to the waveguide via an optical adhesive for example. In this example version, the thin film may operate as the optical output coupling obviating need for direct scoring into the waveguide. While scoring the waveguide is a most preferred mode, thin film backplane elements arranged in this way should be considered viable alternatives. Light which enters the protective scatter sheet 39 passes therethrough or is subject to further homogenous scattering.

Via this illustration, another very important feature and element of these flooring systems is detailed and explained here. The protective scatter sheet 39 is not always permanently affixed to the light panel system. Rather, in most important versions, the protective scatter sheet is removable and replaceable by a strong adhesive 310 coupling.

With sufficient peeling force applied, the protective scatter sheet may be removed from the waveguide or other portion of the light panel system and replaced with a fresh new one whenever a protective scatter sheet has been subject to excessive wear which tends to damage the scatter sheet. Because of stage flooring tends to be subject to very rough handling and is occasioned by extreme wear and tear, a replaceable protective scatter sheet preserves the waveguide element and the entire light panel to assure a very long system lifetime in view of repeated installation and uninstallation.

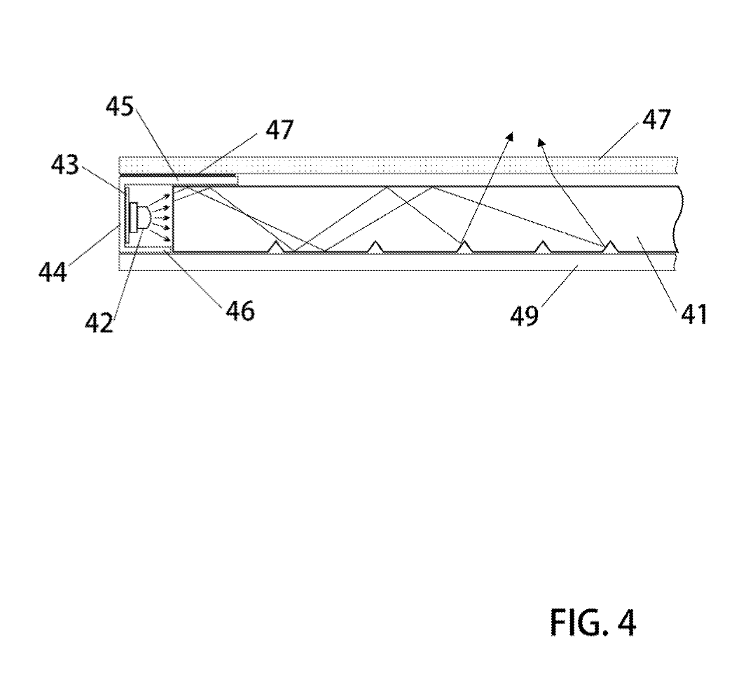

One most important preferred version is illustrated in FIG. 4. In this arrangement, direct mechanical support for light source mounting and optical coupling with respect to a preferred example of a waveguide is shown. Specifically, waveguide body 41 fabricated of transparent materials such as synthetic polymer of methyl methacrylate, polycarbonate, or so-called ‘acrylic glass’ and sometimes under the brand name Plexiglas®. Alternatively, where high-strength properties are demanded a clear polycarbonate or acrylic may be preferred.

Light sources 42 of these systems are preferably semiconductor diodes which emit narrowband or ‘single color’ light. LEDs are easy to energize electrically, highly durable, very compact in size, and inexpensive. They are amenable to systems in which they are energized together as a group or alternatively operated as a singly as separate elements. For example, elongated strip circuit board 43 may be arranged to accommodate several LEDs in a common electrical circuit. Application of current to a single circuit may energize many LEDs at once. In the drawing, the symmetry axes is into the page and it is to be understood that many LEDs lie behind the one shown and that the single LED illustrated in the drawing is meant to represent an array of similar identical devices.

A special edge bracket 44 serves as a mechanical and thermal coupling to hold a linear array of LED type light sources in close proximity to the edge of a waveguide slab. In preferred versions, this mounting bracket may be made of aluminum as it is highly durable, easy to machine and inexpensive.

The shape shown in the drawing is particularly useful because it may be fully aligned and coupled to the waveguide in one easy step. An ‘overlap” portion 45 may be glued to the top surface of the waveguide while strip 46 accurately aligns, mechanically indexes, and spaces the system merely by making contact with the waveguide at its face edge.

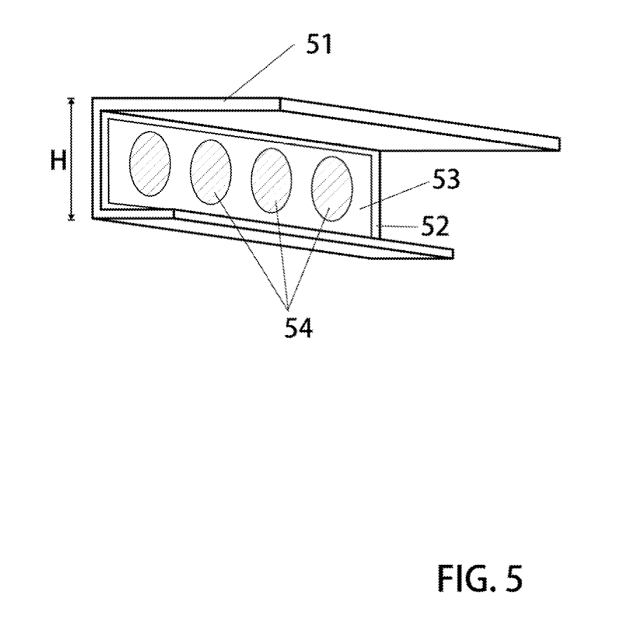

An edge bracket assembly, (see FIG. 5) comprising a plurality of LED light sources mounted to a circuit board and supporting electronic circuitry is affixed in the bracket at suitable receiving surface, it is adhered to the waveguide via single surface area defined by the area 47 common to the waveguide and the edge bracket as shown. In this version, the protective scatter sheet 47 is affixed adjacent to the top side of the waveguide via adhesive applied to the edge bracket 44. The backplane element 49 may be durably affixed to both the waveguide bottom surface and the edge bracket as shown. Together, such construction is herein referred to as a ‘lighted panel’ or ‘light panel’.

One will gain a more clear appreciation for the nature and construct of an example edge bracket 51 in view of the perspective drawing of FIG. 5. An aluminum extrusion forms an interior mounting surface 52 to which a circuit board 53 may be affixed and secured. The circuit board may have mounted thereon a plurality of light sources 54, notably those characterized as light emitting diodes and in particular diodes of particular colors such as red, green and blue which may be arranged to operate independently to achieve various colors.

While the illustrative examples of FIGS. 4 and 5 present a most useful high performance example version of a preferred light panel arrangement it should be noted the invention remains intact when alternative arrangements are embraced. For example, it is possible to fabricate a light panel element and system for lighted floors in accordance with the primary teachings and claimed invention but where the mounting bracket and/or circuit board is omitted.

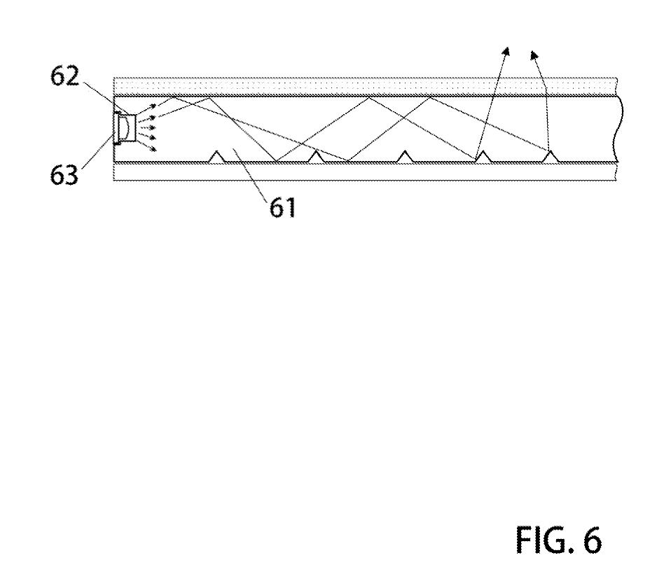

FIG. 6 illustrates that LED light sources may be mounted into a recess formed into a plastic waveguide 61 recess 62 machined into the edge face of the waveguide slab and LEDs 73 may be cemented into those recesses to form a similar light panel which performs nearly as well. It should not be considered a deviation or traverse of this invention to adopt such simple variations which do little to serve the overall objectives and the spirit of a nature of these systems. While many floor lighting systems enjoy aspects which impart an even illumination field, those systems are generally quite thick and have complex geometric structures as a result. Because these systems are arranged about thin planar panels with light sources disposed at the perimeter or edge of the panels, it has heretofore been a complex problem to achieve even illumination without significantly increasing the expense of the overall system.

One way to achieve even illumination field is to provide scoring or cut grooves into the surface of the waveguide. These grooves may be inexpensively made in simple machine processes. As the scoring operates to scatter incident light, it causes light to be coupled out of the waveguide and into the light panel illumination fields.

Accordingly the spatial distribution of scoring affects the uniformity of the illumination field. Since the light sources are arranged distributed about the light panel periphery, these light panels include scoring in geometric patterns which promote homogeneous light field outputs in preferred versions. If the scoring were uniform, regular and periodic, the light panel would tend to have a “dark” spot far from the light sources. Accordingly, to achieve even lighting, these light panels are arranged with increased scoring as a function of distance from the panel peripheral edge.

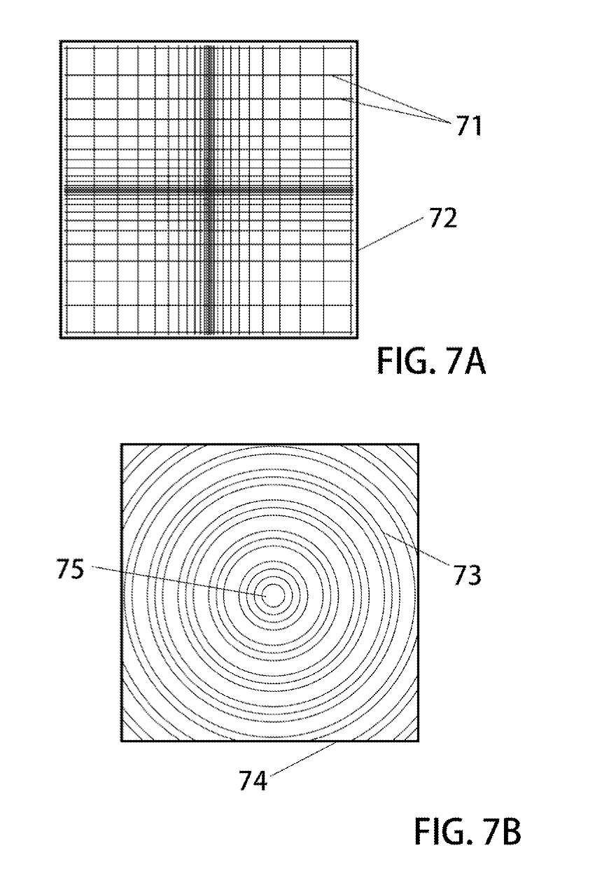

FIGS. 7A and 7B illustrate two examples of such spatially distributed scoring. In FIG. 7A, linear score grooves 71 are provided where the spacing between them in each orthogonal direction decreases as one moves from the panel periphery 72 towards the panel center. Similarly, scored groove density increases in the example illustrated as FIG. 7B where circular grooves 73 are cut into the waveguide 74 top surface where the number of grooves per inch is increased as one moves radially inward toward the center 75.

With the foregoing detailed descriptions of particulars relating to light panel elements well at hand, the following descriptions include details relating to cooperating flooring structure and staging frame matrix systems.

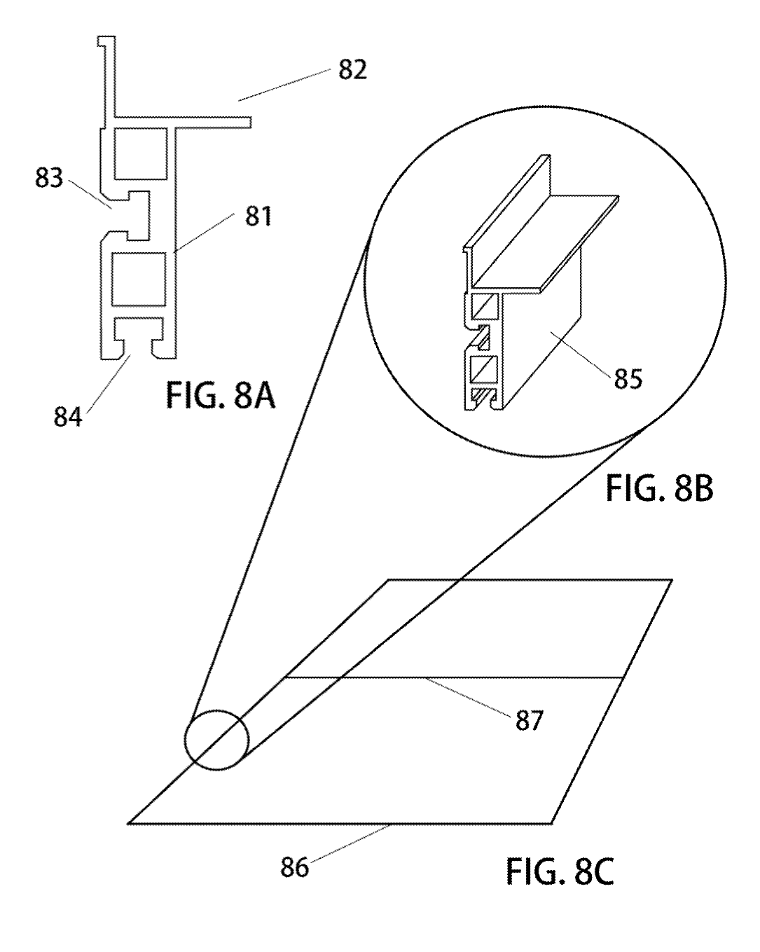

A first important aspect of these frame matrix systems is a metal extrusion 81 material used to fabricate a unit frame. A cross-section depiction of stock material used to fabricate frame elements is illustrated in FIG. 8A. Extruded aluminum is particularly suitable as it is lightweight, easy to machine and weld, and is inexpensive as well as durable. The particular extrusion shape supports two major important functions including providing a receiving shelf 82 and mechanical interlock couplings 83 and 84. The extrusion is further shown in a perspective detail 85 drawing in FIG. 8B where the nature of the construction may be better understood. From such extruded material, a rectangular frame element 86 is fabricated, in preferred modes having an aspect ratio of 2:1 with cross member 87 dividing the rectangle into two squares into which light panels shown previously are fitted and secured.

Of course it should be clear to all readers that while the precise dimensions and sizes lend useful aspects and in particular with regard to portability, alternatives and modifications to those specifications remain under the umbrella from which the invention is defined.

In America, construction materials have a linear dimension which is commonly specified in units and/or multiples of 48 inches or 4 feet. Because of this, it is quite convenient to fabricate flooring structures to cooperate with those dimensions as this tends to reduce fabrication costs due in part to cutting for example. Further, it is a 4′×4′ area should be considered a natural size with regard to a performing arts stage. The human eye has a certain ability to resolve images and scenes and when viewing a stage having a lighted floor comprised of many discrete elements (pixels), a natural size for each element is preferably of the order of 4′×4′. As such, a frame of FIG. 8C is preferably made of an extruded aluminum lengths welded together to make an 8′×4′ structure of two square units into which light panels may be firmly inserted and mounted. Each 8′×4′ frame is referred to herein as a ‘repeat unit’. Because a typical stage floor is comprised of an area of many thousands of square feet, it is best to construct these lighted stage floors via a paving scheme whereby many repeat units are placed side-by-side to cover the entire stage. Since the frame described herein must be coupled to adjacent units and to a subfloor, the mechanical interlock couplings 83 and 84 are provided. Mechanical interlock couplings 83 permit one frame to be firmly locked to and joined with adjacent frames when a complementary fitting is inserted into the slots formed in the extrusions. Similarly, mechanical interlock couplings 84 disposed at the bottom of a frame permits of these frames to be similarly securely bound and fastened down to a suitable receiving subfloor. When a plurality of these repeat units are installed together as described, a very large area, multiple pixel color lighted floor system is realized.

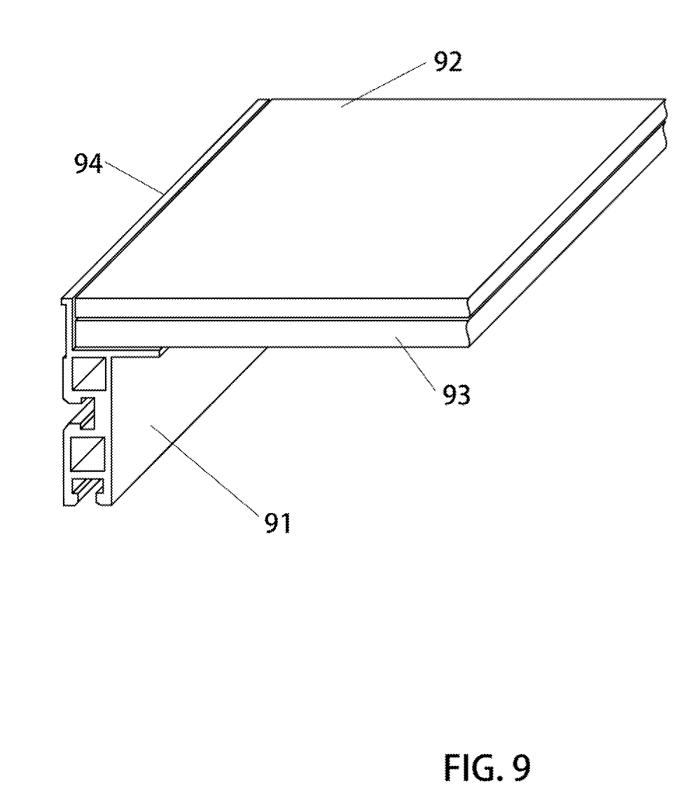

Once a plurality of frame units are installed tightly coupled to the subfloor and tightly coupled to each adjacent frame, it is a simple and easy matter to insert cooperating light panels. FIG. 9 illustrates a cutaway perspective view of a frame 91 in accordance with these teachings having therein a light panel 92 and a support board 93. A support board, for example a common plywood material, is sometimes used to provide added strength for heavy-duty applications where the strength of a Plexiglas waveguide alone is insufficient to support heavy weights and pressures put upon some floors. A support board may be made of common plywood cut into a 4′×4′ square thus matching the profile of the light panel and the receiving shelf 94 of the frame unit.

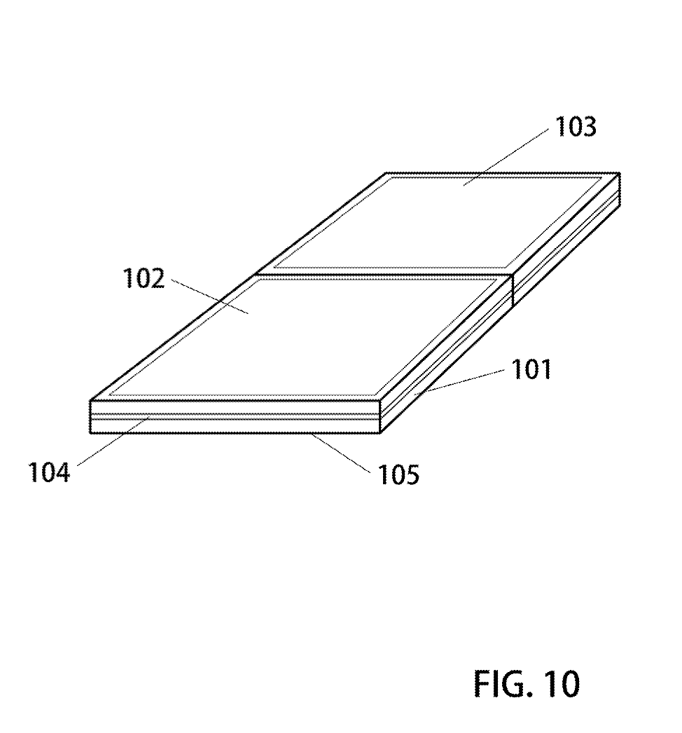

FIG. 10 illustrates a completed repeat unit 101 with two light panels inserted therein a rectangular frame structure in a 2:1 array configuration. Slot 104 forms a receiving cavity which supports mechanical interlock couplings to adjacent cooperating structures including identical repeat unit frames. At the frame underside, a similar slot 105 aids in fastening these frames to a suitably prepared to subfloor or scaffolding or truss structures. Large area lighted stage floors are formed when a plurality of these repeat units 111 are fastened together to pave a stage 112 surface. While these systems are particularly amenable to being formed as a plurality of the linear units, it is not necessary that the periphery of any panel actually be rectangular. Other polygons are fully anticipated. Indeed, certain artistic advantage is realized when hexagon shaped peripheries 122 are used to form these light panels and cooperating frames. A groove pattern suitable for square panels may not be suitable for hexagon panels in view of uniformity, however a bit of engineering care suggests groove patterns which could result in a nice even coupling of light from a waveguide into a light field emitted from the floor panel. A similar large area lighted floor 121 is realized and makes a very nice stage surface for performing arts.

One will now fully appreciate how highly durable, temporary lighted stages having a high degree of uniformity may be fabricated, assembled and used. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

1) Lighted floor panels comprising:
a waveguide;
a plurality of light sources; and
an optical output coupling,
said waveguide is a substantially planar substrate having a peripheral edge of at least three sides,
said plurality of light sources are spatially distributed about said peripheral edge whereby light emitted from those sources enters the waveguide transversely, and
said optical output coupling is arranged to couple light propagating in said waveguide through a top surface of the waveguide.

2) Lighted floor panels of claim 1, further comprising a protective scatter sheet thin substrate adjacent to and parallel with said waveguide at its top surface.

3) Lighted floor panels of claim 2, said scatter sheet is affixed to said waveguide via an adhesive which enables the scatter sheet to be easily removed and replaced with a replacement scatter sheet.

4) Lighted floor panels of claim 2, further comprising a metal edge bracket of three planar sides to form a receiving space into which a printed circuit board may be affixed.

5) Lighted floor panels of claim 4, further comprising a printed circuit board affixed within said receiving space of the edge bracket with an electronic circuit and plurality of light sources integrated therewith.

6) Lighted floor panels of claim 4, said scatter sheet is affixed to said edge bracket via an adhesive which enables the scatter sheet to be easily removed and replaced with a replacement scatter sheet.

7) Lighted floor panels of claim 1, said optical output coupler is further characterized as scattering sites distributed about and formed into an optical surface of said waveguide.

8) Lighted floor panels of claim 7, said optical output coupler is further characterized as a set of grooves cut into a surface of said waveguide substrate.

9) Lighted floor panels of claim 8, said groove set is further characterized as a set of grooves whose density increases as a function of distance from the peripheral edge of said waveguide.

10) Lighted floor panels of claim 1, further comprising a backplane element affixed to a bottom surface of said waveguide, the backplane element has a surface nearest the waveguide which reflects light incident thereon back into the waveguide.

11) Lighted floor panels of claim 1, further comprising a backing board having profile similar to that of the waveguide, said waveguide and said backing board when placed together form a strong cooperating multilayer unit.

12) A lighted floor system comprising a plurality of repeat units coupled together, each repeat unit comprising:
a frame element; and
at least one lighted floor panel,
said frame element is comprised of elongated sections affixed together to form polygon areas including a panel receiving cavity,
said lighted floor panel or panels are affixed into a receiving cavity formed by said frame element.

13) A lighted floor system of claim 12, said elongated sections are formed of extruded metal having mechanical interlock receiving slots formed therein at the section sides, whereby frame elements may be securely coupled and fastened together by mechanical means.

14) A lighted floor system of claim 12, said elongated sections are formed of extruded metal having mechanical interlock receiving slots formed therein at the section bottom edges, whereby frame elements may be securely coupled and fastened to a cooperating subfloor.

15) A lighted floor system of claim 12, said lighted floor panel is inserted into said receiving space whereby the top surface of the lighted panel is flush with respect to a top edge of the frame.

16) A lighted floor system of claim 12, said frame element is characterized as a 2:1 system having two panel receiving cavities per frame.

17) A lighted floor system of claim 16, each of said panel receiving cavities are characterized as a square measuring about 48 inches on a side.

18) A lighted floor system of claim 12, said panel receiving cavity is characterized as a non-rectangular polygon.
